(19) United States
(12) Patent Application Publication
(10) Pub. No.: US 2008/0196159 A1
(43) Pub. Date: Aug. 21, 2008

(54) Method and apparatus for soft-feel plumbing fixtures

(76) Inventor: William A. Lee, Wheaton, IL (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/998,823

(22) Filed: Nov. 30, 2007

Related U.S. Application Data
(60) Provisional application No. 60/861,873, filed on Nov. 30, 2006.

(51) Int. Cl. E03C 1/04; B05D 7/22

(52) U.S. Cl. 4/678; 427/230

(57) ABSTRACT

A soft-feel plumbing fixture having a rigid internal structure encased by a generally “soft-feel” protective coating. Depending upon fixture style, the rigid internal structure can be a fluid conduit or valve stem. The “soft-feel” protective coating can be applied over an intermediate support structure that functions to separate the rigid internal structure from direct physical contact with the soft-feel protective coating. The soft-feel protective coating protects a user from potential injury as a result of falls or other accidents which can cause the user to accidentally bump or fall upon the plumbing fixture. Representative soft-feel plumbing fixtures can include single-handle faucets, wide spread and center-set faucets, sink spouts, tub spouts, handles, shower heads and the like. The soft-feel protective coating can be applied over the intermediate support structure so as to resemble decorative themes, animals, dinosaurs, mascots, fictional characters, sporting equipment and the like.

### PRIORITY CLAIM

The present application claims priority to U.S. Provisional Application Ser. No. 60/861,873 filed Nov. 30, 2006, and entitled “METHOD AND APPARATUS FOR SOFT-FEEL PLUMBING FIXTURES”, which is herein incorporated by reference in its entirety.

### FIELD OF THE INVENTION

The present invention relates generally to plumbing fixtures. More specifically, the present invention relates generally to soft-feel plumbing fixtures incorporating a rigid internal structure and their related methods of construction.

### BACKGROUND OF THE INVENTION

Plumbing fixtures including faucet, shower and tub fixtures are available in a wide variety of styles and configurations. Typically, consumers select a desired style so as to correspond with a desired decorative theme within a bathroom or kitchen. In fabricating these fixtures, a variety of materials are commonly used based on both their appearance and ability to accommodate the range of water temperatures typically experienced. Commonly used materials include various metals, for example, stainless steel and brass, that can be plated or otherwise treated to provide any of a wide variety of surface finishes and colors.

While these plumbing fixtures work very well for their intended purpose and are successfully used to enhance the aesthetic appearance of one's bathroom, they can suffer from several inherent disadvantages that are part and parcel of their construction. For instance, the potential exists for bathers to be injured while using a tub or shower by falling or otherwise hitting themselves on a faucet or spout. Also, these plumbing fixtures can include sharp edges, for instance at a spout outlet, that can cause cuts when a user inadvertently bumps into said edge. These dangers are multiplied for small children and the elderly.

In order to reduce these risks, a variety of solutions have been attempted. First, a variety of soft covers have been developed that can be stretched over so as to enclose a fixture. Unfortunately, these covers often do not fit properly and may interfere with proper operation of the fixture. In another bid to overcome these risks, “soft”, flexible fixtures have been developed as disclosed in U.S. Pat. No. 6,775,866, which is herein incorporated by reference.

While these previous developments have reduced the injury risks associated with rigid fixtures, it would be advantageous to have a fixture that simultaneously reduces injury risks while maintaining the performance of current rigid designs.

### SUMMARY OF THE INVENTION

A plumbing fixture of the present disclosure can comprise a rigid internal structure encased by a generally “soft-feel” protective coating. In some representative embodiments, the rigid internal structure can comprise a fluid conduit or a valve stem. The “soft-feel” protective coating can be applied over a support structure that functions to separate the rigid internal structure from direct physical contact with the soft-feel protective coating. Presently contemplated embodiments can comprise fittings such as, for example, single-handle faucets, wide spread and center-set faucets, spouts, tub spouts, handles and shower heads. In some representative embodiments, the soft-feel protective coating can cause the plumbing fixture to resemble decorative themes, animals, dinosaurs, fictional characters, sporting equipment and the like.

In one aspect, the present disclosure is directed to a plumbing fixture having a rigid internal structure, an intermediate support structure and a soft-feel exterior coating. The rigid internal structure can comprise a fluid conduit or valve stem and can be fabricated of suitable materials including metals such as stainless steel and brass. The intermediate support structure can comprise a rigid cage that is injection molded directly over the rigid internal structure. Alternatively, the rigid cage can comprise a two-piece snap-fit structure. The intermediate support structure can comprise suitable polymeric materials that are compatible with elevated temperatures including, for example, glass-filled polypropylene. The soft-feel exterior coating is applied directly over the intermediate support structure through a suitable process such as, for example, hand casting, foam and/or injection molding. The soft-feel exterior coating can comprise rubber and rubber-like coatings applied at a thickness of at least about 1 mm. In some embodiments, the soft-feel exterior coating can be applied so as to resemble children friendly objects including, for example, decorative themes, animals, dinosaurs, fictional characters, sporting equipment and the like.

In another aspect, the present disclosure is directed to a method for fabricating a soft-feel plumbing fixture. In a first step, a rigid internal fixture structure is provided such as, for example, a fluid conduit or valve stem. In a second step, an intermediate support structure is positioned so as to enclose the rigid internal fixture structure. In some embodiments, the intermediate support structure can be injection molded around the rigid internal fixture structure or alternatively, can be provided in a snap-fit configuration that is snapped over the rigid internal fixture structure. In a third step, a soft-feel exterior material is applied over the intermediate support structure. The soft-feel exterior material can comprise a rubber or rubber-like material that can be hand cast or injection molded over the intermediate support structure.

In yet another aspect of the present disclosure, a plumbing fixture system can be provided for protecting small children and the elderly from injury. The plumbing fixture system can comprise various fixtures including sink and tub faucets. Each fixture can comprise a soft-feel exterior layer applied over an intermediate support structure that isolates the soft-feel exterior form a rigid internal structure. In some representative embodiments, the plumbing fixture system can be fabricated such that the soft-feel exterior layer possesses an appealing aesthetic appearance to children and adults such as, for example, decorative themes, animals, dinosaurs, fictional characters, sporting equipment and the like.

The above summary of the various representative embodiments of the invention is not intended to describe each illustrated embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a front, elevational view of an embodiment of a center set faucet assembly of the present disclosure;

FIG. 2 is a rear, elevational view of the center set faucet assembly of FIG. 1;

FIG. 3 is a top view of the center set faucet assembly of FIG. 1;

FIG. 4 is a bottom view of the center set faucet assembly of FIG. 1;

FIG. 5 is a side view of the center set faucet assembly of FIG. 1;

FIG. 6 is a top, perspective view of the center set faucet assembly of FIG. 1;

FIG. 7 is a section view of a soft-feel faucet spout taken at line 7-7 of FIG. 1;

FIG. 8 is a front view of an embodiment of a soft-feel tub spout;

FIG. 9 is a rear view of the soft-feel tub spout of FIG. 8;

FIG. 10 is a top view of the soft-feel tub spout of FIG. 8;

FIG. 11 is a bottom view of the soft-feel tub spout of FIG. 8;

FIG. 12 is a side view of the soft-feel tub spout of FIG. 8;

FIG. 13 is a top, perspective view of the soft-feel tub spout of FIG. 8; and

FIG. 14 is a section view of the soft-feel tub spout of FIG. 8 taken at line 14-14 of FIG. 8.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE PREFERRED EMBODIMENTS

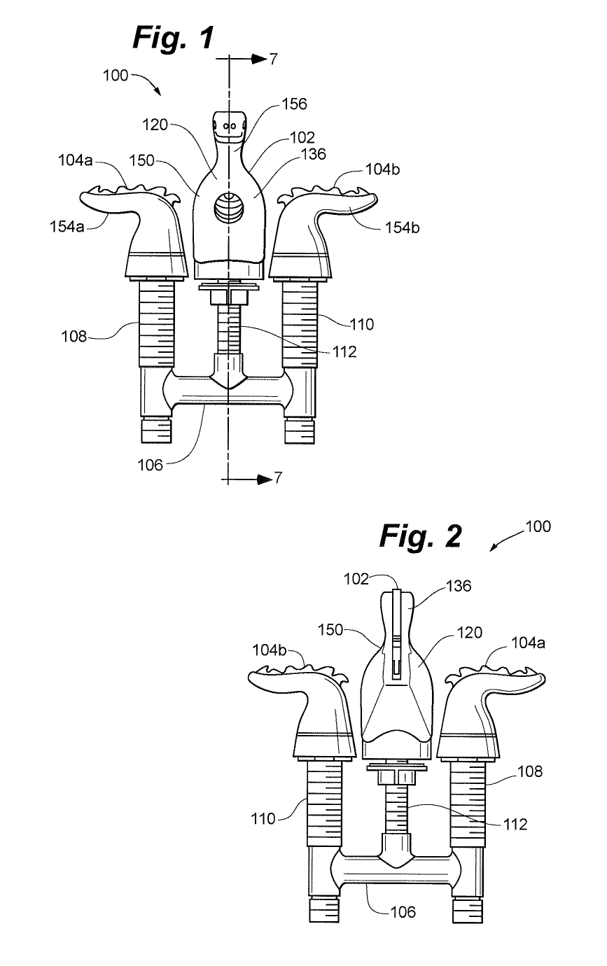

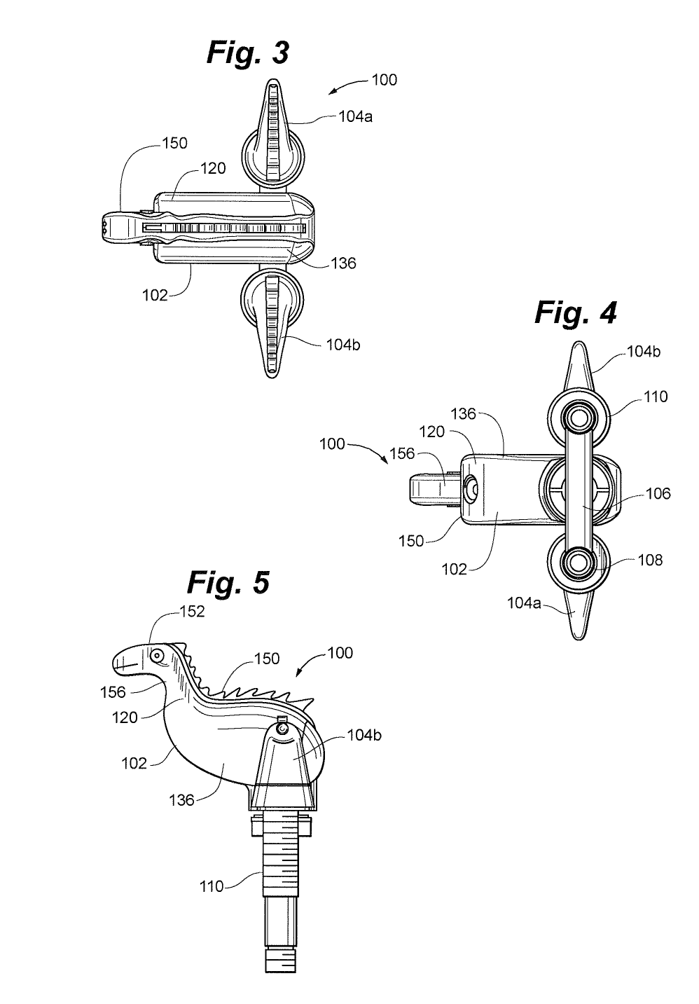

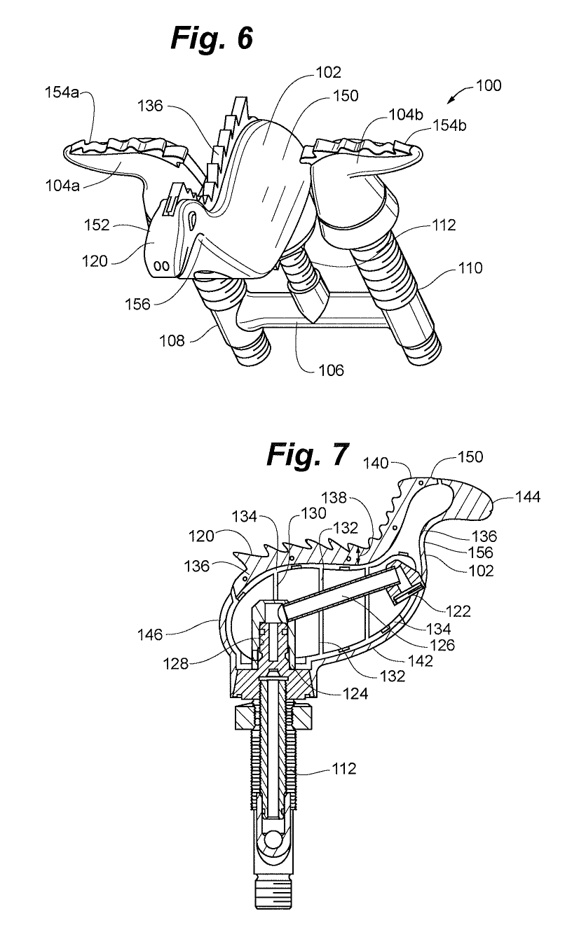

As illustrated in FIGS. 1-7, a representative embodiment of a generally soft-feel plumbing fixture of the present disclosure can comprise a soft-feel center-set faucet assembly 100. Soft-feel center-set faucet assembly 100 generally comprises a soft-feel faucet spout 102 and a pair of soft-feel faucet handles 104a, 104b. Soft-feel center-set faucet assembly 100 is operably attached to supply plumbing assembly 106 having a hot water supply portion 108, a cold water supply portion 110 and a dispensing portion 112. While the soft-feel plumbing fixture in FIGS. 1-7 is illustrated in a center-set configuration, it will be understood that the novel construction and soft-feel characteristics of the present disclosure can be similarly applied to a single handle faucet design and other faucet or plumbing fixtures known in the art.

Referring again to FIGS. 1-7, soft-feel faucet spout 102 can generally comprise a soft-feel body 120, a dispensing aperture 122 and a connecting aperture 124. Generally, dispensing aperture 122 and connecting aperture 124 are at least partially defined by a rigid or generally rigid fluid conduit 126 that can comprise a connecting feature 128 at the dispensing aperture 122. The connecting feature 128 can comprise suitable plumbing connector styles including, for example, internal threads, snap-fit and compression-fit connectors for providing a leak-free connection between the rigid fluid conduit 126 and the dispensing portion 112. Rigid fluid conduit 126 can be constructed of materials capable of withstanding prolonged exposure to elevated water temperatures including, for example, brass, copper, stainless steel and molded engineering resins such as polythalamide, glass filled polythalamide, polyether amide, glass reinforced polyether amide, and mixtures thereof.

Within the soft-feel faucet spout 102, an intermediate support structure 130 surrounds the rigid fluid conduit 126 such that the only accessible portions of the rigid fluid conduit 126 are at the dispensing aperture 122 and connecting aperture 124 as illustrated in FIG. 7. Intermediate support structure 130 can comprise a plurality of rib members 132 extending between the rigid fluid conduit 126 and a perimeter support surface 134. Intermediate support structure 130 can be fabricated of rigid or semi-rigid materials that are compatible with elevated water temperatures which are conducted through the rigid fluid conduit 126. In some embodiments, intermediate support structure 130 and rigid fluid conduit 126 can be fabricated and/or cast as a single component. For example, intermediate support structure can comprise suitable polymeric materials including, for example, glass-filled polypropylene and Acrylonitrile Butadiene Styrene (ABS). Other suitable materials such as brass are envisioned as well.

On an exterior portion of the soft-feel faucet spout 102, a generally soft-feel exterior layer 136 can cover the perimeter support surface 134 so as to essentially encase both the intermediate support structure 130 and rigid fluid conduit 126 with the exceptions of the dispensing aperture 122 and connecting aperture 124 as illustrated in FIG. 7. The soft-feel exterior layer 136 generally comprises a natural rubber, synthetic rubber such as, for example, silicone rubber or suitable rubber-like materials including thermoplastic elastomers (TPE's) such as polyurethanes, polyester copolymers, styrene copolymers, olefinics, polyamides, elastomeric alloys and melt-processible rubbers. The soft-feel exterior layer 136 preferably comprises an exterior thickness 138 of at least 1 mm and in some embodiments, ranging between about 3 mm to about 15 mm. The exterior thickness 138 can be generally consistent around the perimeter support surface 134 or may be variable dependent upon location on the soft-feel faucet spout 102 for example, a top portion 140, a bottom portion 142, a front portion 144 or a rear portion 146. Other suitable materials and material thicknesses are envisioned as well.

To fabricate soft-feel faucet spout 102, a first step generally comprises providing the rigid fluid conduit 126. The rigid fluid conduit 126 is selected based upon desirable materials of construction, desired water flow rates and cost. Next, the intermediate support structure 130 is positioned so as to surround the rigid fluid conduit 126 between the dispensing aperture 122 and the connecting aperture 124. The intermediate support structure 130 can be molded around the rigid fluid conduit 126 so as to essentially fix the orientation of the rigid fluid conduit 126 or alternatively, the intermediate support structure 130 can be provide in two or more pieces that are snap-fit around the rigid fluid conduit 126. Finally, the soft-feel exterior layer 136 is molded or otherwise disposed around the perimeter support surface 134 such that only the dispensing aperture 122 and the connecting aperture 124 remain uncovered. The soft-feel exterior layer 136 can be applied using any of a variety of suitable molding techniques including, for example, hand casting and/or injection molding. Upon application of the soft-feel exterior layer 136, the soft-feel faucet spout 102 can generally comprise a unitary, non-disassemblable component. Other modular configurations are envisioned as well.

In use, the soft-feel faucet spout 102 is generally attached to the dispensing portion 112 using connecting feature 128. When installed, the dispensing aperture 122 is oriented in a generally downward facing orientation with respect to a sink basin. Though not illustrated, it will be understood that soft-feel faucet handles 104a, 104b being constructed in a similar manner as soft-feel faucet spout 102 with a soft-feel exterior layer molded over an intermediate support structure and rigid valve stem are similarly mounted to the hot water supply portion 108, a cold water supply portion 110. As soft-feel faucet handles 104a, 104b are rotated individually or in combination, a stream of water from dispensing portion 112 is released into the connecting aperture 124 where it flows through the rigid fluid conduit 126 and out the dispensing aperture 122. Even under the hottest temperature condition, the intermediate support structure 130 provides a barrier preventing the soft-feel exterior layer 136 from being exposed to and thus warming to this to maximum temperature.

When properly installed, the soft-feel exterior layer 136 prevents injury to a user which can arise from falls and other accidents. For instance, a small child being bathed in a sink basin would be protected from injury due to accidentally falling or bumping themselves against any of the soft-feel faucet spout 102 or the soft-feel faucet handles 104a, 104b. With specific reference to the soft-feel faucet spout 102 which generally projects over and/or into the sink basin, the soft-feel faucet provides protection in every orientation such that none of the rigid fluid conduit 126 is exposed so as to reduce injury potential. At the same time, the structural integrity and functionality of the fixture is maintained.

As illustrated in FIGS. 1-7, soft-feel center-set faucet assembly 100 can be fabricated such that the soft-feel exterior layer 136 has an appealing aesthetic appearance such as for example, a dinosaur 150 with the soft-feel faucet spout 102 configured as the dinosaur body 152 and the soft-feel faucet handles 104a, 104b as dinosaur tails 154a, 154b. To further promote the look of dinosaur 150, the soft-feel exterior layer 136 can be applied in a variety of different colors. Dinosaur body 152 generally includes a flexible neck portion 156 solely comprising the soft-feel exterior layer 136 applied over the intermediate support structure 130. In this way, the injury potential of flexible neck portion 156 is reduced. As will be understood by one of ordinary skill in the art, a variety of alternative appearances can be presented including, for example, decorative themes, animals, mascots, fictional characters, sporting equipment and the like.

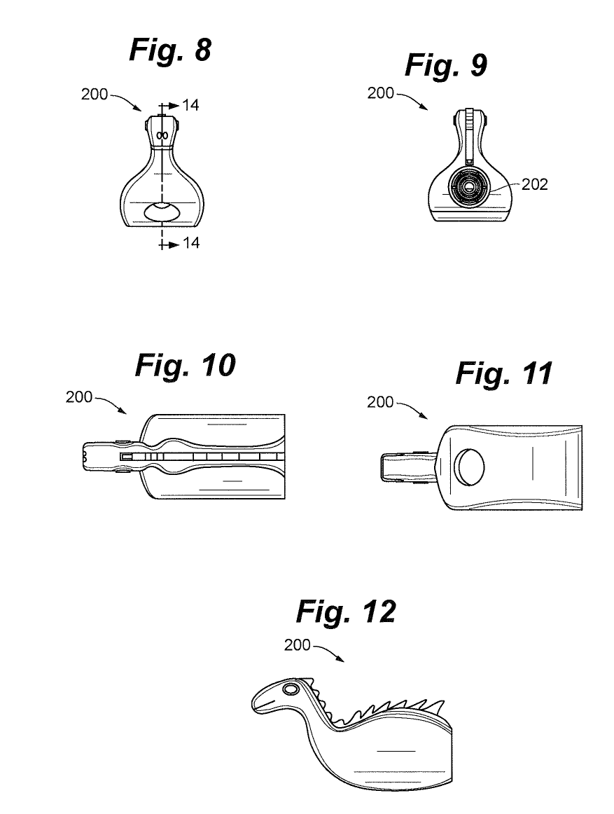

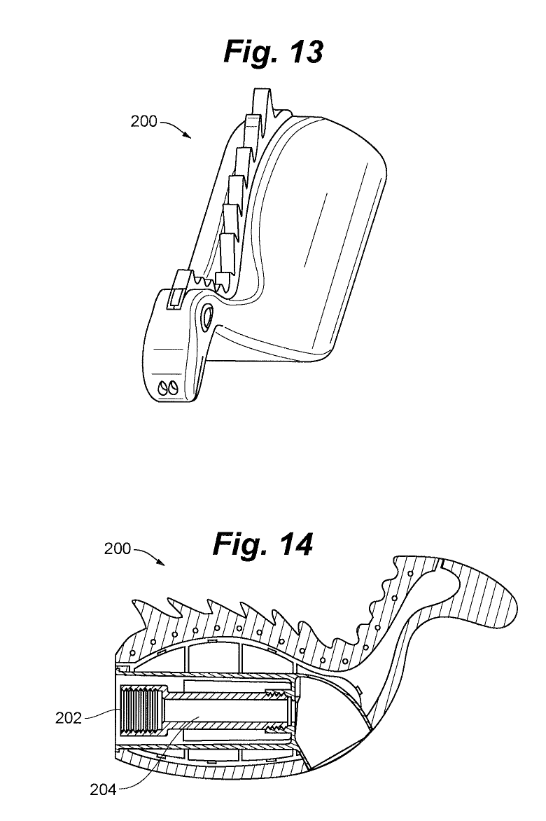

A representative embodiment of a soft-feel tub spout 200 is illustrated in FIG. 8-14. Soft-feel tub spout 200 can be similar to soft-feel faucet spout 102 in both construction and appearance. In some embodiments, the soft-feel tub spout 200 can be configured such that a connecting aperture 202 presented by a rigid fluid conduit 204 is ready for flush mounting on a generally vertical surface of a tub basin. Regardless of mounting orientation, soft-feel tub spout 200 presents the same safety benefits as soft-feel faucet spout 102 and is especially advantageous with regard to possibility of slip and fall accidents that are possible in bathtubs.

Although the present invention has been described and illustrated with respect to various presently contemplated embodiments within the present specification, it will be understood that numerous insubstantial changes in configuration, arrangement or appearance of the elements of the present invention can be made without departing from the intended scope of the present invention. Accordingly, it is intended that the scope of the present invention be determined by the claims as set forth.

What is claimed:

1. A soft-feel plumbing spout comprising:
a rigid fluid conduit having a dispensing aperture and a connecting aperture;
an intermediate support structure surrounding the rigid fluid conduit, the intermediate support structure having a plurality of rib members extending between the rigid fluid conduit and a perimeter support surface of the intermediate support structure; and
a soft-feel exterior layer covering the perimeter support surface, the soft-feel exterior layer generally encasing the intermediate support structure and the rigid fluid conduit while providing access to the dispensing aperture and the connecting aperture.

2. The soft-feel plumbing spout of claim 1, wherein the rigid fluid conduit and intermediate support structure are cast as a single as a single component.

3. The soft-feel plumbing spout of claim 1, wherein the intermediate support structure comprises a pair of support structures, said pair of support structures snapping in position over the rigid fluid conduit.

4. The soft-feel plumbing spout of claim 1, wherein the rigid fluid conduit comprises a heat-resistant material selected from the group consisting of: brass, copper, stainless steel and molded engineering resins.

5. The soft-feel plumbing spout of claim 4, wherein the intermediate support structure is selected from a rigid or semi-rigid material selected from the group consisting of: glass-filled polypropylene, ABS, brass, copper and stainless steel.

6. The soft-feel plumbing spout of claim 5, wherein the soft-feel exterior layer is selected from a material selected from the group consisting of: a natural rubber, synthetic rubber or rubber-like materials.

7. The soft-feel plumbing spout of claim 1, wherein the soft-feel exterior layer comprises a rubber or rubber-like material present in an exterior thickness ranging between about 1 mm to about 15 mm.

8. The soft-feel plumbing spout of claim 1, wherein the connecting aperture includes a connecting feature selected from the group consisting of: a threaded connector, a snap-fit connector and a compression-fit connector.

9. The soft-feel plumbing spout of claim 1, wherein the connecting aperture is presented in a flush-mount configuration.

10. A soft-feel plumbing assembly comprising:
a spout comprising:
a rigid fluid conduit having a dispensing aperture and a connecting aperture;
an intermediate spout support structure surrounding the rigid fluid conduit, the intermediate spout support structure having a plurality of spout rib members extending between the rigid fluid conduit and a spout perimeter support surface of the intermediate spout support structure; and
a spout soft-feel exterior layer covering the spout perimeter support surface, the spout soft-feel exterior layer generally encasing the spout intermediate support structure and the rigid fluid conduit while providing access to the dispensing aperture and the connecting aperture; and
at least one handle comprising:
a rigid valve stem;
an intermediate handle support structure surrounding the rigid valve stem, the intermediate handle support structure having a plurality of handle rib members extending between the rigid valve stem and a handle perimeter support surface of the intermediate handle support structure; and
a handle soft-feel exterior layer covering the handle perimeter support surface.

11. The soft-feel plumbing assembly of claim 10, further comprising:
a pair of handles including a hot water handle and a cold water handle.

12. The soft-feel plumbing assembly of claim 11, wherein the spout and the pair of handles define a soft-feel center-set faucet assembly.

13. The soft-feel plumbing assembly of claim 10, wherein the spout and the at least one handle define a selected aesthetic appearance.

14. A method for fabricating a soft-feel plumbing fixture comprising:
providing a rigid internal fixture structure; and
applying a soft-feel exterior material over the rigid internal fixture structure to form an integral fixture structure.

15. The method of claim 14, further comprising:
enclosing the rigid internal fixture structure with an intermediate support structure such that the soft-feel exterior material is applied to the intermediate support structure.

16. The method of claim 15, wherein enclosing the rigid internal fixture structure with the intermediate support structure comprises snapping a pair of support structure members over the rigid internal fixture structure.

17. The method of claim 15, wherein enclosing the rigid internal fixture structure with the intermediate support structure comprises molding the intermediate support structure over the rigid internal fixture structure.

18. The method of claim 14, where the rigid internal fixture structure is selected from a group comprising: a rigid fluid conduit and a rigid valve stem.
